(19) United States
(12) Patent Application Publication
(10) Pub. No.: US 2009/0043518 A1
(43) Pub. Date: Feb. 12, 2009

(54) METHOD FOR ASSIGNING PEAK CODES USING REGION PARTITION SCHEME, THE PEAK CODES FOR THE METHOD, AND METHOD FOR PREDICTING/DIAGNOSING FAULTY OPERATION OF MECHANICAL DEVICE USING PEAK CODES

(75) Inventors: Chang-Su ROH, Busan-si (KR); Ui-Pil CHONG, Ulsan-si (KR)

Correspondence Address: CANTOR COLBURN, LLP, 20 Church Street, 22nd Floor, Hartford, CT, 06103, US

(73) Assignee: Sung-Chan DO, Ulsan-si (KR)

(21) Appl. No.: 12/186,210

(22) Filed: Aug. 5, 2008

(30) Foreign Application Priority Data
Aug. 9, 2007 (KR) 10-2007-0080016

(51) Int. Cl. G01N 29/12

(52) U.S. Cl. 702/56

(57) ABSTRACT

A method for assigning a peak code using a region partition scheme, the peak code for use in the method, and a method for diagnosing a faulty operation of the mechanical device using the peak code are disclosed. The method analyzes a frequency of either a unique operation sound or vibration signal generated when each normal-status mechanical device is operated, acquires a normal peak code, and compares the acquired normal peak code with a measurement peak code acquired by analyzing a frequency of either a unique operation sound or vibration signal measured from a measurement-objective mechanical device, such that it determines the presence or absence of a faulty operation of each mechanical device according to the result of the comparison.

### BACKGROUND OF THE INVENTION

1. Field of the Invention

The present invention relates to a method for assigning a peak code using a region partition scheme, which analyzes a frequency of either a unique operation sound or vibration signal generated when each normal-status mechanical device is operated, acquires a normal peak code, and compares the acquired normal peak code with a measurement peak code acquired by analyzing a frequency of either a unique operation sound or vibration signal measured from a measurement-objective mechanical device, such that it determines the presence or absence of a faulty operation of each mechanical device according to the result of the comparison, the peak code for use in the method, and a method for diagnosing a faulty operation of the mechanical device using the peak code.

2. Description of the Related Art

As the operation time of each mechanical device for use in industrial fields increases, the possibility of generating a faulty operation in the mechanical device also increases due to abrasion of components of the mechanical device. In the case of expendable supplies from among all components of the mechanical device, it is preferable that each expendable supply be periodically inspected or replaced with a new one. Specifically, a large-sized mechanical device includes a large number of rotary or movable components which produce friction against peripheral components. So, if the maintenance and management of the large-sized mechanical device are carelessly carried out, an unexpected faulty operation may occur in a specific part of the large-sized mechanical device, such that all operations of the mechanical device are not carried out.

In the meantime, in the case of a power plant for generating the power and transmitting this power to individual households or industrial facilities, if the power generating action is temporarily interrupted due to faulty operations of some installations of the power plant, the huge amount of loss may arise. Specifically, most installations of the power plant are large-sized devices and high-priced devices. So, if an unexpected faulty operation occurs in any installations of the power plant, a user or administrator has difficulty in quickly repairing this faulty operation.

Therefore, there is proposed a system which periodically inspects the presence or absence of a faulty operation in the mechanical device, periodically replaces old expendable supplies with new expendable supplies, or predicts whether the faulty operation of the mechanical device occurs, the proposed system is placed at a position at which various mechanical devices (e.g., the power plant installations) are driven, such that it prevents the amount of damages or loss from increasing. In this way, the above system aims to prevent the faulty operation.

A representative system capable of predicting or diagnosing the faulty operation of industrial installation is as follows. This system monitors the vibration or noise signal generated from the mechanical device, converts the monitored vibration or noise signal into a digital signal, and compares a normal-status digital signal with an abnormal-status digital signal. The signal processing technique for diagnosing the faulty operation of the mechanical device uses a Root Mean Square (RMS) value, a peak-to-peak value, and a crest factor in a time area, and uses a spectrum analysis method in a frequency area. In this way, if the vibration or noise signal generated from the mechanical device is analyzed in the frequency area, total characteristics and total errors of signals can be easily recognized by the analyzed result.

A Fast Fourier Transform (FFT) scheme has been widely used as the above-mentioned technique for analyzing the vibration or noise signal generated from the mechanical device in the frequency area. However, the above FFT scheme has a disadvantage in that a calculation speed is too late to process a large amount of data. Also, if the calculated data is used as an input value of the system, the above FFT scheme requires other calculations.

In the meantime, there are a variety of conventional arts which can diagnose status information of a mechanical device or predict a faulty operation thereof, e.g., a vibration analysis method for predictive maintenance of a mechanical device has been disclosed in Korean Patent Laid-open Publication No. 10-2004-0015339, and a method and system for diagnosing status information of a rotational machine has been disclosed in Korean Patent Registration No. 10-0666452.

### SUMMARY OF THE INVENTION

Accordingly, the present invention is directed to a method for assigning a peak code using a region partition scheme, the peak code for the same method, and a method for diagnosing a faulty operation of a mechanical device using the peak code that substantially obviate one or more problems due to limitations and disadvantages of the related art.

It is an object of the present invention to provide a method for assigning a peak code using a region partition scheme, which analyzes a frequency of either a unique operation sound or vibration signal generated when each normal-status mechanical device is operated, acquires a normal peak code, and compares the acquired normal peak code with a measurement peak code acquired by analyzing a frequency of either a unique operation sound or vibration signal measured from a measurement-objective mechanical device, such that it determines the presence or absence of a faulty operation of each mechanical device according to the result of the comparison, in addition, the peak code for use in the method, and a method for diagnosing a faulty operation of the mechanical device using the peak code.

In accordance with one aspect of the present invention, the above and other objects can be accomplished by the provision of a method for assigning a peak code using a region partition scheme comprising: a) acquiring either an operation sound or vibration signal generated when a mechanical device is operated; b) performing a Fast Fourier Transform (FFT) scheme on a frequency of either the operation sound or the vibration signal, and indicating a magnitude of the FFT-resultant frequency on a FFT graph composed of several FFT cells which include intervals of predetermined frequency bands and predetermined-sized intervals; c) determining whether a peak value is located at each FFT cell, searching for the highest peak value from among individual peak values, and determining the searched peak value to be a maximum peak value; d) dividing a vertical-axis area into a predetermined number of equal division parts on the basis of a height of the maximum peak value, and indicating the FFT-resultant frequency magnitude on a normal graph composed of several normal cells which include intervals of predetermined frequency bands and predetermined-sized intervals; e) searching for the highest peak value from among several peak values located at each horizontal-axis interval having the predetermined frequency-band interval in the normal graph, and determining the searched peak value to be an interval peak value; f) indicating a specific character ‘F’ at a head part of resultant information acquired by the above steps a) e) in order to simultaneously represent the resultant information in the form of a code-format visual value, in which the specific character ‘F’ indicates that a code has already been acquired when the frequency of either the operation sound or the vibration signal is analyzed according to the FFT scheme; g) indicating not only a frequency division interval but also a character ‘X’ indicating a horizontal-axis division interval at a position located behind the ‘F’ character, and indicating not only the number of equal division parts acquired from the vertical axis of the normal graph on the basis of the maximum peak value but also a character ‘Y’; h) sequentially indicating peak addresses at a position located behind the ‘Y’ character in the order of frequency areas in order to compare a peak value of each interval with the maximum peak value using an integer ratio, indicating the maximum peak value by a specific character ‘P’, and indicating the remaining interval peak values by integers marked on the normal graph such that vertical-axis area coordinates of each normal cell including each interval peak value are indicated by the integers; and i) numerically indicating the maximum peak value of the FFT graph at a position behind the indicated peak address of the step h).

Preferably, the method further comprises indicating a sign to easily discriminate areas located between the peak address and the maximum peak value at either the step h) for indicating the peak address by the ‘P’ character or numerals or the step i) for numerically indicating the maximum peak value of the FFT graph.

Preferably, the horizontal axis of the step g) for establishing an interval between the FFT cells on the FFT graph is divided by a frequency band of 100 Hz.

Preferably, the vertical axis of the step g) for dividing the normal cell of the normal graph into a predetermined number of equal parts has a specific maximum peak value which allows the predetermined number of equal parts to be ‘10’.

Preferably, the step c) for determining whether the peak value is located at each FFT cell, searching for the highest peak value from among the individual peak values, and determining the searched peak value to be the maximum peak value further includes: determining whether the number of peak values contained in each normal cell including the interval peak value is at least ‘2’; and if it is determined that the at least two values are located in the normal cell including the interval peak value, additionally indicating the determined information at a peak address.

Preferably, the number of peak values contained in the normal cell including the indicated interval peak value is represented by script at one side of an upper part of each peak address.

In accordance with another aspect of the present invention, there is provided a peak code comprising: code-formatted characters and numbers according to the method of claim 1, wherein the code-formatted characters and numbers are printed on a paper.

Preferably, the paper is configured in the form of a sticker capable of being attached to a mechanical device.

In accordance with another aspect of the present invention, there is provided a method for diagnosing a faulty operation of a mechanical device using a peak code comprising: a) comparing a normal peak code acquired from a normal-state mechanical device with a measurement peak code acquired from a measurement-objective mechanical device according to the method of claim 1, and determining whether the result of the comparison between the normal peak code and the measurement peak code exceeds a range of an allowable error; and b) if the comparison result between the normal peak code and the measurement peak code exceeds the range of the allowable error, determining that the measurement-objective mechanical device is in an abnormal status such that a faulty operation of the measurement-objective mechanical device is predicted.

Preferably, the step a) for comparing the normal peak code with the measurement peak code includes: determining whether there is a difference in location between cells, each of which includes a character ‘P’.

The present invention analyzes the frequency of an operation sound or vibration signal measured at the mechanical device, and assigns a peak code including operation information of the mechanical device according to the analyzed result, such that it can be easily applied to a system for predicting a faulty operation of the mechanical device such as a power plant, and at the same time is able to predict in real time the presence or absence of any faulty operation in the mechanical device.

If the present invention is applied to the process for inspecting whether a poor or inferior product occurs, it can more correctly and quickly discriminate between a good product (i.e., a normal-status product) or a poor product (i.e., an abnormal-status product), such that the number of poor products can be greatly reduced at the manufacturing process of products.

Specifically, if the present invention is applied to all the mechanical devices (e.g., a barcode reader), each of which generates the operation noise, a user or administrator can easily perform the post management of the corresponding product, resulting in greater convenience of use.

### BRIEF DESCRIPTION OF THE DRAWINGS

The above objects, and other features and advantages of the present invention will become more apparent after reading the following detailed description when taken in conjunction with the drawings, in which:

FIG. 1 is a conceptual diagram illustrating an exemplary peak code according to the present invention;

FIG. 2 is a block diagram illustrating a process for assigning a peak code according to the present invention;

FIG. 3 is an exemplary screen image of a monitoring system for use in the process for assigning the peak code according to the present invention;

FIG. 4 is an exemplary region partition of an FFT graph according to the present invention;

FIG. 5 is an exemplary region partition of a normal graph according to the present invention;

FIG. 6 is an exemplary peak code according to one embodiment of the present invention;

FIG. 7 is a normal graph according to another embodiment of the present invention;

FIG. 8 is an exemplary peak code according to another embodiment of the present invention;

FIG. 9 is a conceptual diagram illustrating Labview for use in the range from a first process for acquiring an operation sound of a generator and a second process for estimating a faulty operation according to the present invention; and

FIG. 10 is a conceptual diagram illustrating a region partition scheme based on a matrix format according to the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

A method for assigning a peak code using a region partition scheme, the peak code for the same method, and a method for diagnosing a faulty operation of a mechanical device using the peak code according to the present invention will hereinafter be described with reference to the annexed drawings.

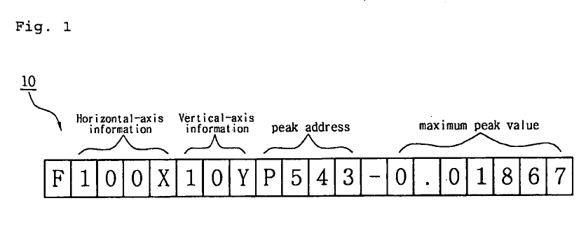

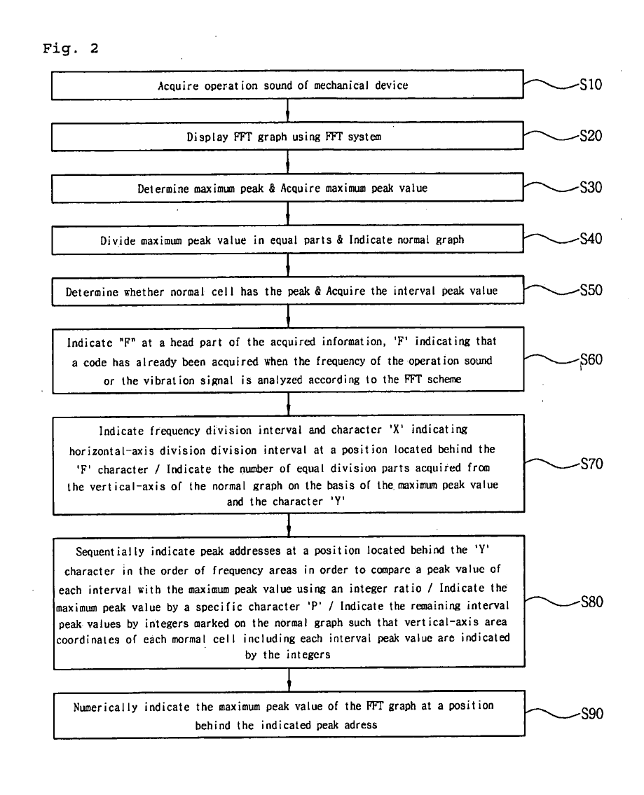

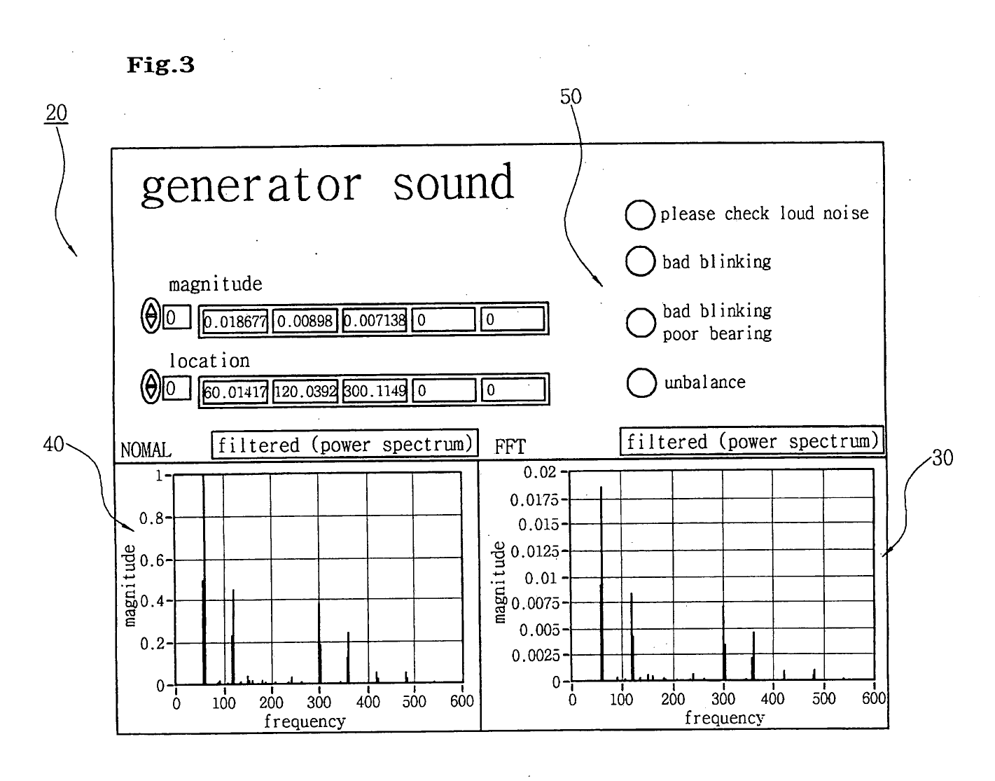

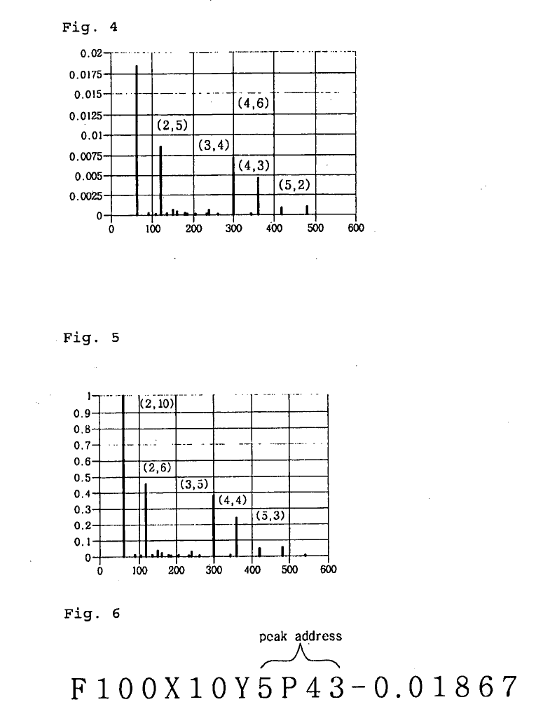

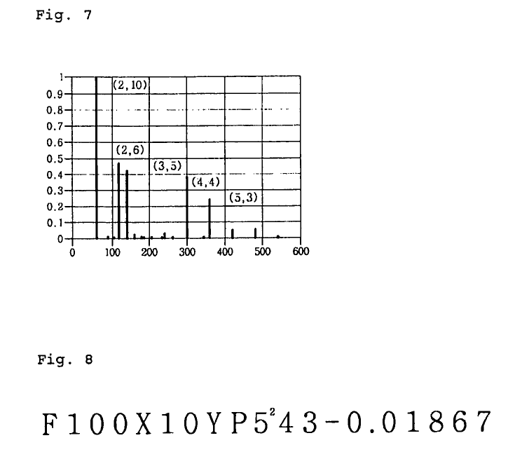

FIG. 1 is a conceptual diagram illustrating an exemplary peak code according to the present invention. FIG. 2 is a block diagram illustrating a process for assigning a peak code according to the present invention. FIG. 3 is an exemplary screen image of a monitoring system for use in the process for assigning the peak code according to the present invention. FIG. 4 is an exemplary region partition of an FFT graph according to the present invention. FIG. 5 is an exemplary region partition of a normal graph according to the present invention. FIG. 6 is an exemplary peak code according to one embodiment of the present invention. FIG. 7 is a normal graph according to another embodiment of the present invention. FIG. 8 is an exemplary peak code according to another embodiment of the present invention.

Referring to FIG. 1, a reference number “10” is a peak code according to the present invention.

The peak code 10 is acquired by the following operations. Namely, an operation sound or vibration signal is acquired from a mechanical device, and a unique operation sound or vibration signal of the mechanical device is converted into a code, such that this code is indicative of the peak code 10. As a result, the present invention can easily and quickly estimate or diagnose a faulty operation of the mechanical device.

FIG. 2 is a flow chart illustrating a method for assigning the peak code 10. Referring to FIG. 2, a first step S10 for assigning the peak code 10 is used to acquire an operation sound or a vibration signal generated from the normal-status mechanical device. This operation sound or vibration signal is FFT (Fast Fourier Transform)—processed by the monitoring system 20 of FIG. 3, such that the frequency and the magnitude are indicated on the FFT graph 30 located at a lower right end of the monitoring system 20 which monitors the sound or vibration signal at step S20. The above-mentioned process for analyzing the operation-sound frequency and the vibration-signal frequency using the FFT scheme has been widely used by those skilled in the art, such that a detailed description thereof will herein be omitted for the convenience of description. In this case, a microphone may be used to acquire the sound signal, or an acceleration sensor may be used to acquire the vibration signal.

As can be seen from the FFT graph 30 used as an embodiment of the present invention, peaks capable of being definitely observed by the naked eye are arranged at intervals of 60 Hz, such that they are indicated on the FFT graph 30 while being spaced apart from each other by the interval of 60 Hz. The above-mentioned method for indicating the peak values at regular intervals on the FFT graph 30 is considered to be one of a variety of unique characteristics of individual mechanical devices. Also, although there may arise several peak values, each of which is indicated by a low magnitude according to a driving status of the mechanical device, the present invention performs a variety of processes such as a filtering on the low peak value almost invisible to the naked eye, such that it is able to ignore or discard the low peak value.

FIG. 4 is an exemplary region partition of an FFT graph according to the present invention. Referring to FIG. 4, a horizontal-axis (X-axis) area of the FFT graph 30 is divided into intervals of a predetermined frequency band, and a vertical-axis (Y-axis) area of the FFT graph 3 is divided into intervals of a predetermined amplitude or size. For the convenience of description and better understanding of the present invention, each cell indicated by the predetermined frequency-band interval and the predetermined amplitude or size interval is hereinafter referred to as an FFT cell. Each FFT cell may also be represented by an area (x,y) based on XY coordinates. In this case, the (x,y) area does not indicate coordinate data itself, and indicates a specific area composed of a horizontal part (i.e., the range from the (x-1)-th axis to the x-th axis) and a vertical part (i.e., the range from the (y-1)-th axis to the y-th axis). For example, an exemplary area (3,3) indicated on the FFT graph of FIG. 4 does not indicate coordinate data indicated by a third horizontal axis and a third vertical axis, and indicates a specific area formed by the interval of 200 Hz˜300 Hz on the horizontal axis and the other interval of 0.005˜0.0075 on the vertical axis.

An overall area of the FFT graph 30 is divided into several FFT cells according to the above-mentioned method, and it is determined whether there is a peak value in each FFT cell. In this case, the present invention searches for the highest peak value from among individual peak values, and determines the searched peak value to be a maximum peak value at step S30. The monitoring system 20 of FIG. 3 may also display the peak value and the frequency band, differently from the FFT graph 30. The monitoring system 20 of FIG. 3 displays the maximum peak value (i.e., the first highest peak value) of about 0.01867, and displays the second highest peak value of about 0.00898. The monitoring system 20 further includes an alarm unit 50 for displaying the diagnosis result for a faulty operation of the mechanical device. However, the peak value indicated on the FFT graph is generally indicated by decimals, such that it is difficult to compare the peak values with each other.

Therefore, in order to easily compare the peak values with each other, a normal graph 40 is depicted at a lower left side of FIG. 3 at step S40. The area of the normal graph 40 is divided into equal parts spaced apart from each other by a predetermined interval on the basis of the maximum peak value at step S40. In the case of the normal graph 40, the area of the normal graph 40 may be divided into several cells by a predetermined frequency-band interval and a predetermined-sized interval. For the convenience of description, each of the above-mentioned cells is called a normal cell. In this case, in order to easily compare other peak values with the maximum peak value, it is preferable that the maximum peak value be divided into 10 equal parts.

The present invention determines whether the peak value is located at each normal cell located at the normal graph 40, and a specific area having the highest peak in the horizontal-axis interval is determined to be the interval peak value at step S50. In the case of the normal graph shown in FIG. 5, a normal cell having the interval peak value is (1,10), (2,5), (3,4), or (4,3).

In the meantime, the present invention can visually display a horizontal-axis position, the interval peak value, a vertical-axis position, and the maximum peak value at the same time at step S60, such that the peak code 10 of FIG. 1 is displayed. In this case, the maximum peak value is located at the horizontal-axis position, and the interval peak value and the vertical-axis position are compared with the maximum peak value.

Specifically, the peak value 10 includes not only specific information indicating a method for analyzing a frequency of the sound or vibration signal, but also other information indicating division areas of the FFT graph.

Firstly, a specific character ‘F’ is indicated at a head part of the peak code 10 at step S60. This specific character ‘F’ indicates that the frequency of the operation sound or vibration signal of the mechanical device has been analyzed by the FFT system.

When the area of the normal graph 40 is divided into several normal cells, the horizontal-axis division interval and a character ‘X’ are indicated to represent the horizontal-axis interval of the normal cell at step S70. And, the number of equal divided parts and a character ‘Y’ are indicated at step S70, such that it can be recognized how many equal parts are in the maximum peak value located at the vertical axis. For example, if the horizontal axis (i.e., X-axis) of the normal graph is divided by the interval of 100 Hz, ‘100X’ is displayed. If the highest peak value of the vertical axis (i.e., Y-axis) is divided into 10 equal parts, ‘10Y’ is displayed. In more detail, if the horizontal-axis information and the vertical-axis information are simultaneously indicated, ‘100X10Y’ is displayed. If frequency analysis information is additionally indicated, ‘F100X10Y’ is displayed.

A peak address is indicated at the next column at which the frequency analysis information denoted by ‘F100X10Y’ and the normal graph's region partition information are located. The height of the interval peak value indicated on the normal graph 40 is compared with the highest peak value on the basis of an integer ratio in the order of frequency areas. In this case, the highest peak value is indicated by ‘P’, and the remaining interval peak values compared with the highest peak value are indicated by integers marked on the normal graph such that vertical-axis area coordinates of each normal cell including each interval peak value are indicated by the integers at step S80. In other words, referring to the peak code 10 of FIG. 1, it can be recognized that that normal cell having the highest peak value is located at an area of (1,y). Referring to the other peak code 10 of FIG. 6, it can be recognized that the normal cell having the highest peak value is located at an area of (2,y).

Specific information indicating the maximum peak value is numerically indicated at a position behind the column at which the peak address is indicated at step S90. In this case, the present invention considers that the maximum peak value is denoted by decimals on the condition that the frequency of the operation sound or vibration signal of the mechanical device has been analyzed by the FFT system, such that the above-mentioned frequency of the operation sound or vibration signal is denoted by decimals. Namely, it can be recognized that the maximum peak value is 0.01867 on the basis of the peak code 10 of FIG. 1.

The second column of the peak address contained in the peak code 10 shown in FIG. 1 is denoted by ‘5’, such that the interval peak value of an area (2,y) is denoted by the half of the maximum peak value. In other words, only the maximum peak value is directly indicated on the peak value 10, the direct indication of the interval peak value is omitted from the peak code 10, such that the interval peak value of the second horizontal-axis area can be estimated to be about 0.009355. In the meantime, the monitoring system of FIG. 3 displays the second interval peak value of 0.00898 on the horizontal axis.

Specifically, a specific sign (e.g., a negative sign (−)) may be located between a first column for indicating the peak address and a second column for indicating the highest peak value.

The present invention determines whether another peak value is in the normal cell including the interval peak value. If the above normal cell includes at least 2 peak values, specific information indicating the presence of the at least 2 peak values may also be indicated in the peak code 10. In this case, in order to indicate the above specific information, script may be added to one side of an upper part of a corresponding column in the peak address. In other words, if the FFT analysis result indicates that any normal cell including the interval peak value includes at least 2 peak values, this information indicating the presence of the at least 2 peak values is indicated at the peak address. For example, if the normal cell of the area (2,5) marked on the normal graph includes 2 peak values as shown in FIG. 7, the peak address of the peak code can be represented by P5²43 shown in FIG. 8.

The peak code 10 assigned by the above-mentioned method may be printed on a paper such as a sticker in the same manner as in a barcode, and may also be directly printed on the mechanical device.

In this way, the present invention can acquire the peak code 10 by analyzing the frequency of the operation sound or vibration signal acquired from the mechanical device, such that it can diagnose or estimate a faulty operation of the mechanical device using the peak code 10.

In other words, the present invention acquires the operation sound or vibration signal from the normal-status mechanical device, analyzes the frequency of the acquired operation sound or vibration signal, acquires a normal peak code, and displays the normal peak code on the mechanical device. The present invention periodically inspects whether a faulty operation of the mechanical device occurs, and acquires the operation sound or vibration signal of the mechanical device from the above periodic inspection process, such that it can acquire a measurement peak code from the acquired sound or signal according to the above-mentioned method.

The measurement peak code acquired from the periodic inspection process of the mechanical device is compared with the normal peak code. In this case, if the result of the comparison between the measurement peak code and the normal peak code exceeds the range of an allowable error, a user can estimate or predict the occurrence of any error in the corresponding mechanical device.

The above step for comparing the measurement peak code with the normal peak code may include a process for firstly checking a position of a cell including a ‘P’ character of the peak address. In addition, the aforementioned comparing step may include: determining whether the number of measurement peak codes contained in the peak address is different from the number of normal peak code contained in the peak address; and determining whether the maximum peak value of the measurement peak code is different from that of the normal peak code. Needless to say, the comparing step may further include a step for establishing an error range in consideration of a measurement error or the lifetime of the mechanical device.

As described above, the peak value 10 according to the present invention can be applied to high-priced and large-sized devices (e.g., installations for power plant) and small-sized devices to which a sufficient number of sensors cannot be attached.

Specifically, when components of a corresponding mechanical device are rotated or move to other places, unique operation sound or vibration signals are generated from the individual components. Based on this characteristic operation, the present invention compares the normal peak value acquired from the normal-status mechanical device with the measurement peak code acquired from the measurement-objective mechanical device, determines whether the rotation component is a poor component, the component is wrongly arranged, or a frictional component (e.g., a bearing) has any problems according to the comparison result. Needless to say, in order to more accurately perform the above determination, the present invention analyzes the frequency of the operation sound or vibration signal changeable with various states of the mechanical device, and configures the analyzed result in the form of a database (DB).

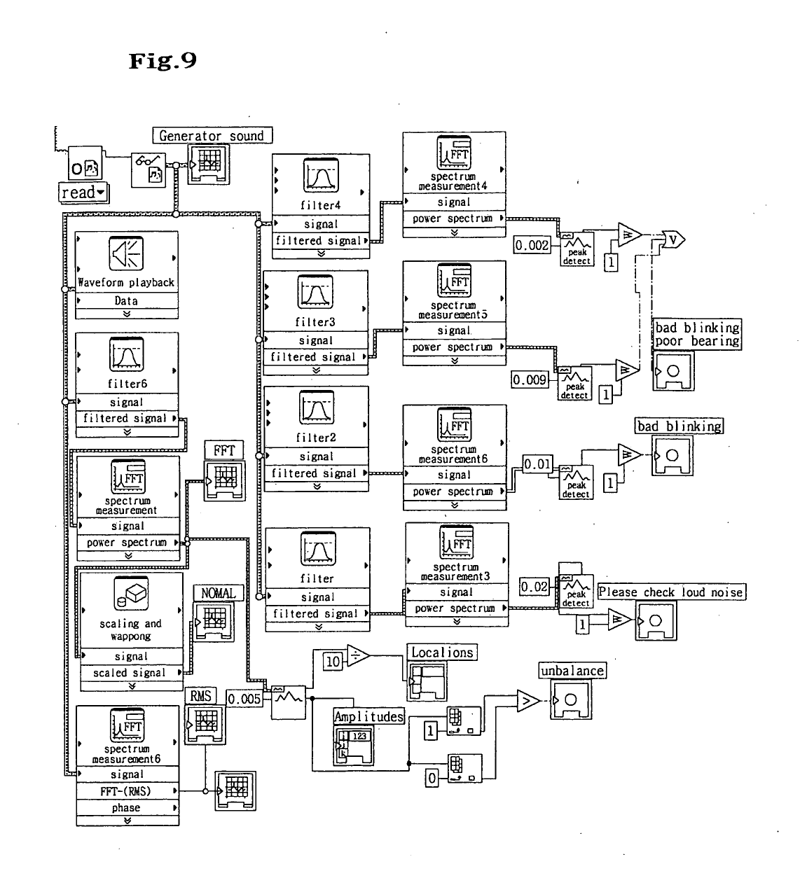

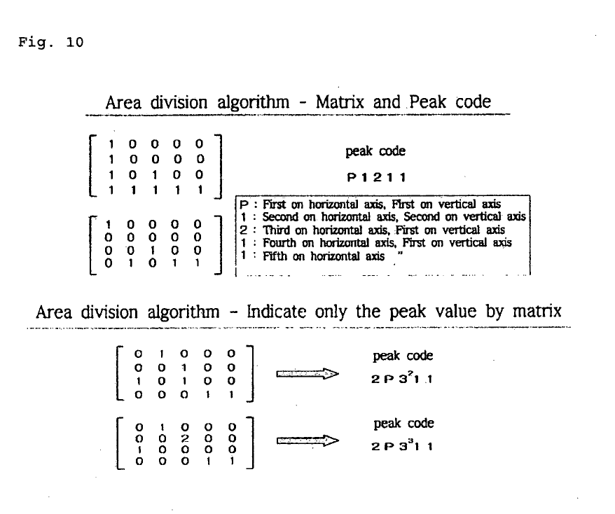

FIG. 9 is a conceptual diagram illustrating Labview for use in the range from a first process for acquiring an operation sound of a generator and a second process for estimating a faulty operation according to the present invention. Needless to say, the algorithm of the present invention is not limited to only the Labview of FIG. 8, and can also be applied to other examples as necessary.

FIG. 10 shows a matrix equation illustrating a method for dividing the frequency area according to the present invention. During the region partition process, the FFT-based frequency characteristics can be represented by the matrix equation of FIG. 10. The value marked in this matrix may be represented by a peak address acting as some parts of the peak code. Provided that at least 2 peak values are contained in the divided frequency area, a first peak code acquired when there is a peak value in the same cells on the vertical axis and a second peak code acquired when there is a peak value in different cells on the vertical axis may be represented in different ways according to the algorithm of the matrix equation of FIG. 10.

As apparent from the above description, the present invention analyzes the frequency of an operation sound or vibration signal measured at the mechanical device, and assigns a peak code including operation information of the mechanical device according to the analyzed result, such that it can be easily applied to a system for predicting a faulty operation of the mechanical device such as a power plant, and at the same time is able to predict in real time the presence or absence of any faulty operation in the mechanical device.

If the present invention is applied to the process for inspecting whether a poor or inferior product occurs, it can more correctly and quickly discriminate between a good product (i.e., a normal-status product) or a poor product (i.e., an abnormal-status product), such that the number of poor products can be greatly reduced at the manufacturing process of products.

Specifically, if the present invention is applied to all the mechanical devices (e.g., a barcode reader), each of which generates the operation noise, a user or administrator can easily perform the post management of the corresponding product, resulting in greater convenience of use.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for assigning a peak code using a region partition scheme comprising:
a) acquiring either an operation sound or vibration signal generated when a mechanical device is operated;
b) performing a Fast Fourier Transform 0(FFT) scheme on a frequency of either the operation sound or the vibration signal, and indicating a magnitude of the FFT-resultant frequency on a FFT graph composed of several FFT cells which include intervals of predetermined frequency bands and predetermined-sized intervals;
c) determining whether a peak value is located at each FFT cell, searching for the highest peak value from among individual peak values, and determining the searched peak value to be a maximum peak value;
d) dividing a vertical-axis area into a predetermined number of equal division parts on the basis of a height of the maximum peak value, and indicating the FFT-resultant frequency magnitude on a normal graph composed of several normal cells which include intervals of predetermined frequency bands and predetermined-sized intervals;
e) searching for the highest peak value from among several peak values located at each horizontal-axis interval having the predetermined frequency-band interval in the normal graph, and determining the searched peak value to be an interval peak value;
f) indicating a specific character ‘F’ at a head part of resultant information acquired by the above steps a)˜e) in order to simultaneously represent the resultant information in the form of a code-format visual value, in which the specific character ‘F’ indicates that a code has already been acquired when the frequency of either the operation sound or the vibration signal is analyzed according to the FFT scheme;
g) indicating not only a frequency division interval but also a character ‘X’ indicating a horizontal-axis division interval at a position located behind the ‘F’ character, and indicating not only the number of equal division parts acquired from the vertical axis of the normal graph on the basis of the maximum peak value but also a character ‘Y’;
h) sequentially indicating peak addresses at a position located behind the ‘Y’ character in the order of frequency areas in order to compare a peak value of each interval with the maximum peak value using an integer ratio, indicating the maximum peak value by a specific character ‘P’, and indicating the remaining interval peak values by integers marked on the normal graph such that vertical-axis area coordinates of each normal cell including each interval peak value are indicated by the integers; and
i) numerically indicating the maximum peak value of the FFT graph at a position behind the indicated peak address of the step h).

2. The method according to claim 1, further comprising:
indicating a sign to easily discriminate areas located between the peak address and the maximum peak value at either the step h) for indicating the peak address by the ‘P’ character or numerals or the step i) for numerically indicating the maximum peak value of the FFT graph.

3. The method according to claim 1, wherein the horizontal axis of the step g) for establishing an interval between the FFT cells on the FFT graph is divided by a frequency band of 100 Hz.

4. The method according to claim 1, wherein the vertical axis of the step g) for dividing the normal cell of the normal graph into a predetermined number of equal parts has a specific maximum peak value which allows the predetermined number of equal parts to be ‘10’.

5. The method according to claim 1, wherein the step c) for determining whether the peak value is located at each FFT cell, searching for the highest peak value from among the individual peak values, and determining the searched peak value to be the maximum peak value further includes:
determining whether the number of peak values contained in each normal cell including the interval peak value is at least ‘2’; and
if it is determined that the at least two values are located in the normal cell including the interval peak value, additionally indicating the determined information at a peak address.

6. The method according to claim 5, wherein the number of peak values contained in the normal cell including the indicated interval peak value is represented by script at one side of an upper part of each peak address.

7. A peak code comprising:
code-formatted characters and numbers according to the method of claim 1, wherein the code-formatted characters and numbers are printed on a paper.

8. The peak code according to claim 7, wherein the paper is configured in the form of a sticker capable of being attached to a mechanical device.

9. A method for diagnosing a faulty operation of a mechanical device using a peak code comprising:
a) comparing a normal peak code acquired from a normal-state mechanical device with a measurement peak code acquired from a measurement-objective mechanical device according to the method of claim 1, and determining whether the result of the comparison between the normal peak code and the measurement peak code exceeds a range of an allowable error; and
b) if the comparison result between the normal peak code and the measurement peak code exceeds the range of the allowable error, determining that the measurement-objective mechanical device is in an abnormal status such that a faulty operation of the measurement-objective mechanical device is predicted.

10. The method according to claim 9, wherein the step a) for comparing the normal peak code with the measurement peak code includes:
determining whether there is a difference in location between cells, each of which includes a character ‘P’.
